(19) United States
(12) Patent Application Publication
(10) Pub. No.: US 2026/0003678 A1
(43) Pub. Date: Jan. 1, 2026

(54) DYNAMIC ALLOCATION OF WORK AND DATA ON SPATIAL COMPUTE ARCHITECTURES

(71) Applicants: Advanced Micro Devices, Inc., Santa Clara, CA (US); XILINX, INC., San Jose, CA (US)

(72) Inventors: Joseph MELBER, Longmont, CO (US); Andra BISCA, Renens (CH); Kristof DENOLF, Longmont, CO (US); Gagandeep SINGH, Zurich (CH); Alireza KHODAMORADI, Lafayette, CO (US)

(21) Appl. No.: 18/758,300

(22) Filed: Jun. 28, 2024

(51) Int. Cl. G06F 9/50

(52) U.S. Cl. CPC G06F 9/5016

(57) ABSTRACT

Dynamic allocation of work and data on a spatial compute architecture in which a lead dispatch node dynamically assigns a task of an application to a selected compute tile, and routes a corresponding active message to a local data memory pool of the selected compute tile. The active message may include instructions, data, and/or configuration parameters to enable the selected compute tile to execute the task. If there is insufficient space in the local data memory pool, the lead dispatch node routes the active message to shared memory or to a local data memory pool of another compute tile, and subsequently routes the active message to the local data memory pool of the selected compute tile when space is available. Alternatively, the lead dispatch node may forward the task and the active message to another lead dispatch node.

### TECHNICAL FIELD

Examples of the present disclosure generally relate to dynamic allocation of work and data on spatial compute architectures.

### BACKGROUND

A spatially distributed compute architecture may include an array of compute tiles having respective processing cores, program memories, and data memories. The spatially distributed compute architecture may further include configurable interconnect structures for moving data amongst the compute tiles. The spatially distributed compute architecture may further include a hierarchical memory structure.

A compiler may compile an application to execute on the spatially distributed compute architecture by mapping tasks/processes to physical resources of the architecture in a static fashion (i.e., prior to execution of the application). Statically compiling an application to execute on a spatially distributed compute architecture is challenging due to the complexity of the architecture, memory constraints, timing/synchronization constraints, physical access constraints, and locality constraints.

### SUMMARY

Techniques for dynamic allocation of work and data on spatial compute architectures are described. Examples are provided below with respect to a spatial compute architecture that includes multiple compute tiles having respective compute cores, program memory, and local data memory. The spatial compute architecture further includes a lead dispatch node (e.g., a dedicated one of the compute tiles and/or other dedicated hardware).

An example described herein is an integrated circuit that includes the spatial compute architecture, where the compute cores are able to access the program memories, the local data memories, and memory pools of the respective compute tiles, the memory pools each include the local data memory of the respective compute tile and the local data memory of one or more other ones of the compute tiles, and the lead dispatch node dynamically assigns a task of an application to a selected one of the compute tiles, and routes a corresponding active message to the local data memory pool of the selected compute tile, where the active message include instructions and data to enable the selected compute tile to execute the task.

Another example described herein is a computer program that includes instructions to cause a processor to compile an application to execute on a spatial compute architecture such that the lead dispatch node dynamically assigns a task of the application to a selected one of the compute tiles, and routes a corresponding active message to the local data memory pool of the compute tile, where the active message includes instructions and data to enable the selected compute tile to execute the task.

Another example described herein is a method that includes executing an application on a spatial compute architecture, including assigning a task of the application to a selected one of the compute tiles, by the lead dispatch node, and routing a corresponding active message to the local data memory pool of the selected compute tile, by the lead dispatch node, where the active message includes instructions and data, to enable the selected compute tile to execute the task.

### BRIEF DESCRIPTION OF DRAWINGS

So that the manner in which the above recited features can be understood in detail, a more particular description, briefly summarized above, may be had by reference to example implementations, some of which are illustrated in the appended drawings. It is to be noted, however, that the appended drawings illustrate only typical example implementations and are therefore not to be considered limiting of its scope.

FIG. 1A depicts a system having a spatial compute architecture, according to an embodiment.

FIG. 1B depicts a compute tile of the system of FIG. 1, according to an embodiment.

FIG. 1C depicts a shared memory tile of the system of FIG. 1, according to an embodiment.

FIG. 1D depicts a local data memory pool that includes local data memories that are accessible to a compute tile, according to an embodiment.

FIG. 1E depicts a local data memory pool that includes local data memories that are accessible to a compute tile, according to another embodiment.

FIG. 2 depicts a compiler that compiles an application to execute on a spatial compute architecture, according to an embodiment.

FIG. 3 depicts a logical graph of a task to be mapped to a computing platform, according to an embodiment.

FIG. 4 depicts an example mapping of the task of FIG. 3, according to an embodiment.

FIG. 5 depicts an alternative mapping of the task of FIG. 3, according to an embodiment.

FIG. 6 depicts a method of allocating memory buffers on spatial compute architectures, according to an embodiment.

FIG. 7A depicts a graph of producer/consumer processes, according to an embodiment.

FIG. 7B depicts a graph of the producer/consumer processes of FIG. 7A, conducted via a pooled synchronized circular buffer, according to an embodiment.

FIG. 8A depicts a graph of producer/consumer processes, according to an embodiment.

FIG. 8B depicts a graph of the producer/consumer processes of FIG. 8A, conducted via a pooled synchronized circular buffer, according to an embodiment.

FIG. 9 depicts a subset of compute tiles of the system of FIG. 1, according to an embodiment.

FIG. 10 depicts the subset of compute tiles of system 100, according to another embodiment.

FIG. 11 depicts a compiler that compiles an application to execute on a spatial compute architecture, according to an embodiment.

FIG. 12A depicts local data memory pools of compute tiles of the system of FIG. 1, according to an embodiment.

FIG. 12B depicts the local data memory pools of FIG. 12A, according to an embodiment.

FIG. 12C depicts the local data memory pools of FIG. 12A, according to an embodiment.

FIG. 12D depicts the local data memory pools of FIG. 12A, according to an embodiment.

FIG. 13 depicts a method of dynamically allocating work and data on a spatial compute architecture, according to an embodiment.

To facilitate understanding, identical reference numerals have been used, where possible, to designate identical elements that are common to the figures. It is contemplated that elements of one example may be beneficially incorporated in other examples.

### DETAILED DESCRIPTION

Various features are described hereinafter with reference to the figures. It should be noted that the figures may or may not be drawn to scale and that the elements of similar structures or functions are represented by like reference numerals throughout the figures. It should be noted that the figures are only intended to facilitate the description of the features. They are not intended as an exhaustive description of the features or as a limitation on the scope of the claims. In addition, an illustrated example need not have all the aspects or advantages shown. An aspect or an advantage described in conjunction with a particular example is not necessarily limited to that example and can be practiced in any other examples even if not so illustrated, or if not so explicitly described.

Embodiments herein describe dynamically pooled allocations of memory buffer on spatial compute architectures, and dynamic allocation of work and data on spatial compute architectures.

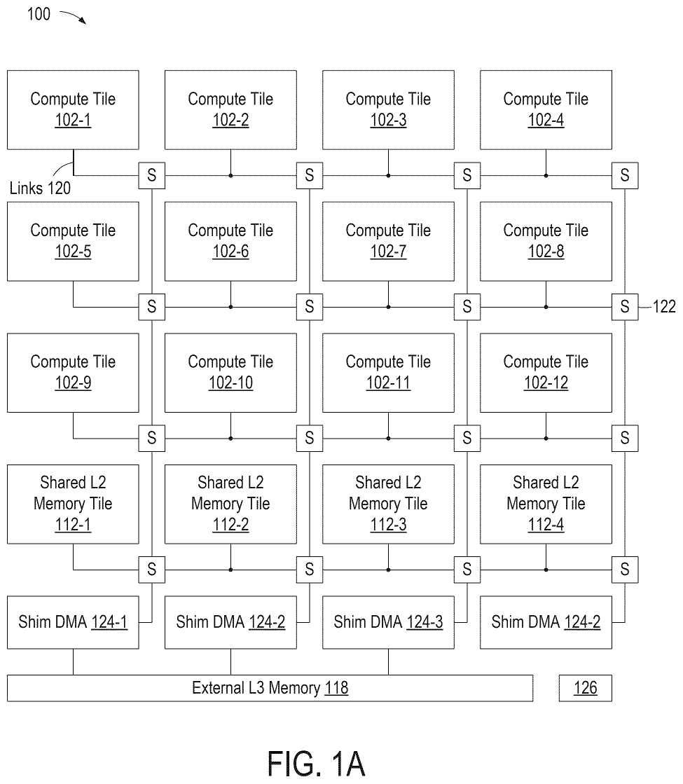

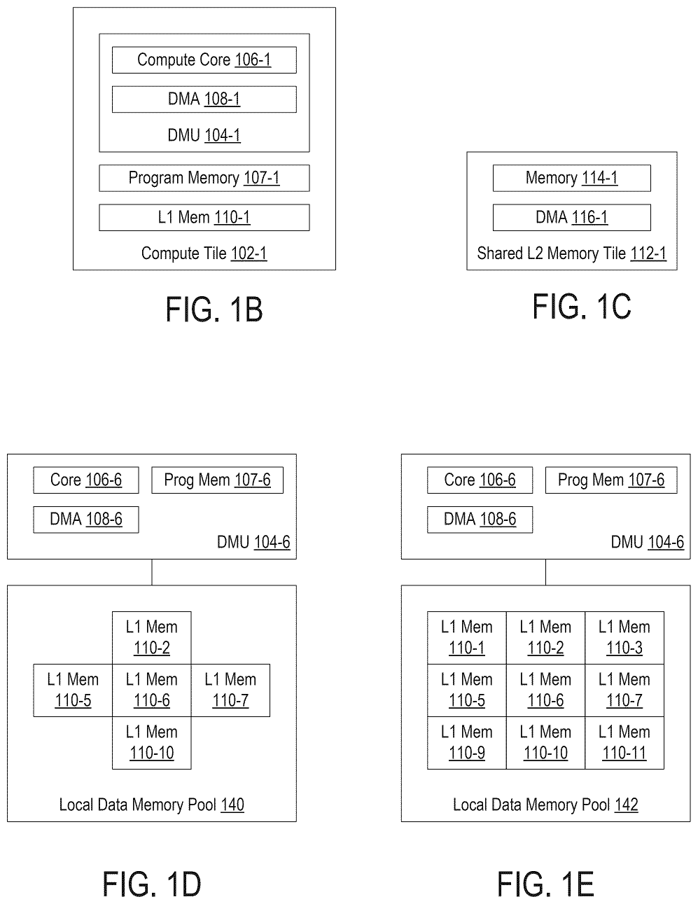

Dynamically pooled allocations of memory buffers on spatial compute architectures are described below with reference to FIGS. 1A through 10. In an example, dynamically pooled allocations of memory buffer on spatial compute architectures include allocating a pooled synchronized circular buffer in place of multiple synchronized circular buffers, where the pooled synchronized circular buffer uses less memory area than the multiple synchronized circular buffers. The pooled synchronized circular buffer may be allocated statically at compile-time and/or dynamically at application run-time.

Dynamic allocation of work and data on spatial compute architectures is described further below with reference to FIGS. 1A, 1B, 1C, and 11 through 13. In an example, local data memories of neighboring compute tiles are pooled to provide each compute tile with a respective local data memory pool. Tasks of an executing application are dynamically assigned to the compute tiles at application runtime based in part on memory availability of the local data memory pools.

A computing platform having a spatial compute architecture may include multiple compute tiles having respective compute cores, data movement accelerators (DMAs), and local memory. The DMAs may include configurable direct memory access engines. The compute cores and DMAs may directly access the respective local memories. The compute cores may also access the local memory of one or more other compute tiles (e.g., adjacent/neighboring compute tiles). The DMAs may exchange data with one another via configurable interconnect structures. The compute core and DMA of a compute tile may be collectively referred to as a data movement unit (DMU).

The local memories may be relatively small, and the computing platform may further include larger memory tiles that are shared amongst the compute tiles. The computing platform may further include DMA shim tiles that interface between the computing platform and external memory. The local memories, the shared memory tiles, and the external memory may form a hierarchical memory structure in which the local memories, the shared memory tiles, and the external memory are referred to as level 1 (L1) memory, level 2 (L2) memory, and level 3 (L3) memory, respectively.

In order to execute an application on the computing platform, a compiler maps or assigns processes/tasks of the application to hardware resources of the computing platform. The compiler may generate code (i.e., instructions) for the compute cores to execute the processes/tasks, and may also generate configuration code and/or configuration parameters to configure the DMAs and interconnects to move data amongst the compute cores and the hierarchical memory structure. Although the local memories provide fast response times for the respective compute cores, the local memories may be relatively small with limited synchronization resources. It can be technically challenging and time consuming for a static compiler to make informed/optimal mapping and synchronization decisions.

Mapping tasks and data movement onto a spatial compute architecture may be performed with open-source technology, which treats incoming and outgoing data flows of tasks as respective consumer and producer processes with their own separate memory spaces. The processes, or “actors” in dataflow theory terminology, have different acquire and release patterns, or actor firing/executing rules, for accessing corresponding reserved memory spaces. The distinction between producer and consumer processes and allocation of separate memory spaces for each result, may result in overuse of the available memory space.

When an application executes on a spatial dataflow architecture, workload tasks (tasks) of the application may be executed by producer and consumer processes that have synchronized access to a shared buffer. The synchronized shared buffer stores data for the tasks, and each process accesses the buffer according to access patterns that describe how the data is acquired and released during the execution of the process. Tasks of different processes may be mapped to neighboring compute tiles, and may have access to shared local memory.

As disclosed herein, when a compiler compiles the application to execute on a target spatial dataflow architecture, the compiler may analyze access patterns of producer and consumer processes to identify mutually exclusive access patterns, and may also analyze execution times of the processes. Based on the analyses, the compiler may combine the synchronized buffers into smaller shared memory spaces, or memory pools.

The compiler may also exploit temporal scheduling of the processes at runtime, where faster processes can continuously make forward progress, to allocate less memory resources that initially required at compile-time. By using the available synchronization resources of the compute tiles, slower processes are not blocked from accessing the shared memory pool when they have finished execution. The resulting memory pools are thus said to be minimally-sized when compared to the total memory requirements of the processes.

Methods disclosed herein reduce or minimize memory usage by generating shared memory pools at compile-time. The memory pools are derived from spatially distributed local memory, based on analyses of access patterns exhibited by producer and/or consumer processes. If the access patterns assure mutual exclusiveness of the processes when accessing data (either through different execution times of the different kernels and/or varying execution time of the kernels themselves), the memory space required by each process can be combined into a spatial shared memory pool, resulting in a smaller memory footprint, with fewer synchronization resources.

The memory footprint may be further reduced as the pools are minimally-sized compared to the total requirements of the processes, based on differences in execution times of the processes. The processes allocate memory space optimally in the shared memory pool in such a way that faster processes continuously make forward progress while the available synchronization resources ensure that the slower processes can advance when ready.

In an example, a compiler analyzes access patterns (e.g., cyclo-static execution/firing rules) of consumer and/or producer processes that have shared access to the local memory of one or more compute tiles, to identify situations in which multiple buffers can be replaced with a pooled buffer having a memory footprint that is less than a sum of the memory footprints of the multiple buffers. The compiler may look for instances of mutual exclusiveness in the execution patterns of the processes, differences in execution times between compute kernels of the processes, and/or variations in execution times of the kernels (i.e., where the execution times relate to application runtime, but are determined at compile-time for the foregoing analysis). The compiler may generate scheduling/controller code and/or configuration parameters to enforce memory allocation/mapping at application run-time.

The compiler may perform an initial mapping of producer and consumer processes onto a target computing platform. In the initial mapping, the compiler may allocate synchronized circular buffers in local memory for pairs of associated producer and consumer processes. The compiler (or a post-compiler) may then analyze access patterns of the producer and consumer processes of adjacent/neighboring compute tiles to determine if a memory footprint of the synchronized circular buffers can be reduced with a shared memory pool.

The compiler may consider consumer processes assigned to neighboring compute tiles (i.e., compute tiles that have shared access to a local memory). The compiler may consider situations in which the corresponding producer processes also have access to the local memory, and/or situations in which the corresponding producer processes do not have access to the local memory. Consideration of both situations may be useful to extend the memory pooling methods to diverse data movement patterns supported by spatial compute architectures.

The compiler may further determine spatial constraints to be imposed on producers and/or consumers, and may generate code and/or configuration parameters for a synchronization/scheduling mechanism to enforce the spatial constraints at application runtime. The synchronization/scheduling mechanism may track producer and/or consumer processes, and may establish/enforce corresponding access schedules.

Alternatively, or additionally, the compiler may analyze execution times of compute kernels in producer and consumer processes of adjacent compute tiles (i.e., compute tiles that have shared access to a local memory), to determine if a memory footprint of the producer and consumer processes can be reduced with a shared memory pool (e.g., a minimally-sized shared memory buffer).

In the following description, data movement is described with reference to tokens, for illustrative purposes. The term “token” is used herein to refer a data object (e.g., a container of data) that is exchanged or moved in an operation, such as when data is written to a buffer or read from a buffer. In some contexts, the term “token” is used herein to refer a right of a data movement accelerator and/or a core to perform an operation on the data object. As an example, a DMA may provide a data object to a core via a synchronized circular buffer. When the DMA completes writing the data object to the synchronized circular buffer, the core is able to read the data object from the buffer. The foregoing process may be described as the DMA transferring a token to the core, and the data object may be referred to as the token. In the foregoing example, the DMA may be referred to as a token producer, and the core may be referred to as a token consumer. Token exchanges may be synchronized between producers and consumers. A consumer may require one or more tokens to perform an operation.

FIG. 1A depicts a system 100, according to an embodiment. System 100 is depicted as computing platform that has a spatial compute architecture. System 100 may serve as a target computing platform for an application program. System 100 may include one or more integrated circuit (IC) dies, ID devices, and/or IC packages.

In the example of FIG. 1A, system 100 includes compute tiles 102-1 through 102-12 (collectively, compute tiles 102). System 100 may include fewer than twelve compute tiles or more than twelve compute tiles. Compute tiles 102, or a subset thereof, may be identical to one another. Alternatively, or additionally, some of compute tiles 102 may differ from one another.

FIG. 1B depicts compute tile 102-1, according to an embodiment. In the example of FIG. 1B, compute tile 102-1 includes a compute core 106-1, program memory 107-1, a data movement accelerator (DMA) 108-1 and local data memory 110-1. Program memory 107-1 may store code/instructions for execution by core 106-1. The code/instructions may represent processes of an application program that is compiled to execute on system 100, such as described further below. DMA 108-1 may include, for example and without limitation, a configurable direct memory access engine. Local data memory 110-1 may store data for use by core 106-1 and/or data produced by core 106-1 when executing code/instructions stored in the program memory 107-1. Local data memory 110-1 may also be referred to as level 1 (L1) memory or local memory. Core 106-1 and DMA 108-1 may include respective store/load units that directly access local data memory 110-1. Core 106-1 and DMA 108-1 may be collectively referred to as a data movement unit (DMU) 104-1. Cores 102-2 through 102-12 may include respective DMUs, cores, DMAs, program memory, and local data memory, which may be collectively referred to as DMUs 104, cores 106, DMAs 108, program memories 107, and local data memories 110.

System 100 may further include shared memory, illustrated here as shared memory tiles 112-1 through 112-4 (collectively, memory tiles 112). System 100 may include fewer than four shared memory tiles or more than four shared memory tiles. FIG. 1C depicts shared memory tile 112-1, according to an embodiment. In the example of FIG. 1C, shared memory tile 112-1 includes memory 114-1 and a DMA 116-1. Memory 114-1 may be directly accessible to DMA 116-1 and to other DMAs of system 100. DMA 116-1 may include, for example and without limitation, configurable direct memory access engines. DMA 116-1 may include a load/store unit that directly accesses memory 114-1. In FIG. 1A, shared memory tiles 112-2 through 112-4 may include respective memories and DMAs. The memories of shared memory tiles 112 may be collectively referred to as memories 114. The DMAs of shared memory tiles 112 may be collectively referred to as DMAs 116.

System 100 may further include shim DMAs 124-1 through 124-3 (collectively, shim DMAs 124), for accessing an external memory 118.

System 100 further includes configurable interconnect structures that provide data paths amongst compute tiles 102, memory tiles 112, and external memory 118. In FIG. 1A, the configurable interconnect structures include links 120, switches 122, The configurable interconnect structures may further include configurable DMA channels. System 100 may further include configuration random-access memory (CRAM) for configuring the interconnect structures, and/or for configuring DMAs 108 of compute tiles 102, DMAs 116 of shared memory tiles 112, and/or shim DMAs 124. In an example, DMAs 108 of compute tiles 102, DMAs 116 of shared memory tiles 112, and shim DMAs 124, or subsets thereof, exchange data with one another via the configurable interconnect structures.

As described further above, the store/load units of a core 106 and a DMA 108 of a compute tile 102 may directly access the local data memory 110 of the compute tile 102. The store/load unit of a core 106 of a compute tile 102 may also directly access the local data memories 110 of one or more other compute tiles 102, examples of which are described below with reference to FIGS. 1D and 1E.

FIG. 1D depicts a local data memory pool 140 that includes local data memories 110 that are accessible to the store/load unit of core 106-6 of compute tile 102-6, according to an embodiment. In the example of FIG. 1D, memory pool 140 includes local data memory 110-6 of compute tile 102-6 and local data memories 110-2, 110-5, 110-7, and 110-10 of respective compute tiles 102-2, 102-5, 102-7, and 102-10.

FIG. 1E depicts a local data memory pool 142 that includes local data memories 110 that are accessible to the store/load unit of core 106-6 of compute tile 102-6, according to another embodiment. In the example of FIG. 1E, memory pool 142 includes local data memory 110-6 of compute tile 102-6 and local data memories 110-1, 110-2, 110-3, 110-5, 110-7, 110-9, 110-10, and 110-11 of respective compute tiles 102-1, 102-2, 102-3, 102-5, 102-7, 102-9, 102-10, and 102-11.

The local memories included in a memory pool may be configurable via configurable interconnect structures and/or via DMAs. Memory pools are not limited to the examples of FIG. 1D or 1E.

System 100 may further include a controller 126 that performs management functions. Controller 126 may, for example, configure DMAs 108, DMAs 116, DMAs 124, and/or the configurable interconnect structures of system 100, based on controller code and/or a configuration bitstream. Controller 126 may include logic and/or a processor and memory encoded with instructions for execution by the processor. Controller 126 may represent a centralized controller and/or control circuitry distributed throughout system 100.

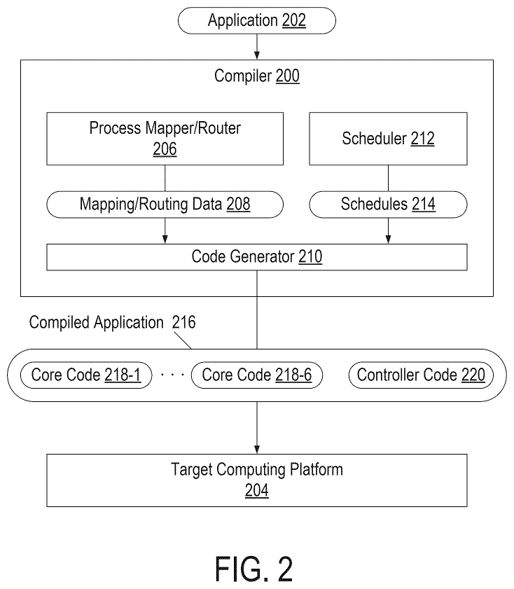

FIG. 2 depicts a compiler 200 that compiles an application 202 to execute on a spatial compute architecture, or computing platform 204, according to an embodiment. In examples below, computing platform 204 represents system 100. Computing platform 204 is not, however, limited to the example of system 100.

Application 202 may represent a variety of types of applications including, without limitation, a trained artificial intelligence/machine-learning (AIML) model. Application 202 may be provided to compiler 200 in a variety of forms such as, without limitation, human-readable source code, register transfer level (RTL) code, a data flow graph, a feature map, an overlay graph, and/or other form(s).

In the example of FIG. 2, compiler 200 includes a process mapper/router 206 that maps processes of application to compute cores 106 of system 100, and determines how to route data amongst elements of system 100 to accomplish the processes. Process mapper/router 206 provides resultant mapping/routing data 208 to a code generator 210.

Compiler 200 further includes a scheduler 212 that determines corresponding schedules 214 for compute tiles 102, shared memory tiles 112, and/or shim DMAs 124. Scheduler 212 may determine schedules 214 based on data flow dependency, control flow dependency, and any specified resource constraints. Schedules 214 may include data transfer schedules and/or kernel execution schedules. Schedules 214 may include dataflow synchronization schedules.

For compute tiles 102, scheduler 212 may determine kernel execution order, and may statically allocate and share resources of compute tiles 102 (e.g., local data memory 110, DMA channels, buffer descriptors, and locks). Scheduler 212 may also determine DMA configurations and lock synchronization for enabling data movement to and from compute tiles 102. For shared memory tiles 112, scheduler 212 may statically allocate and share memory tile resources (e.g., memory 114, DMA channels, buffer descriptors, and locks), and/or other resources of shared memory tiles 112. For shim DMA tiles124, scheduler 212 may statically allocate DMA channels and buffer descriptors.

Code generator 210 generates a compiled application 216 (i.e., machine-readable code) based on mapping/routing data 208 and schedules 214. In the example of FIG. 2, compiled application code 216 includes core code 218-1 through 218-6 for respective tiles 202. Core code 218 may include core for scheduling the kernels on respective cores 106, code for implementing locking mechanisms, and code for moving copy among buffers. Core code 218 may include loadable executable and linkable format (ELF) files. Compiled application 216 may further include controller code 220 for controller 126. Controller code 220 may cause controller 126 to configure shared memory tiles 206, configure DMA registers of shim DMA tiles 124, and/or perform synchronization functions. Controller code 220 may include configuration code/bits for CRAM of system 100.

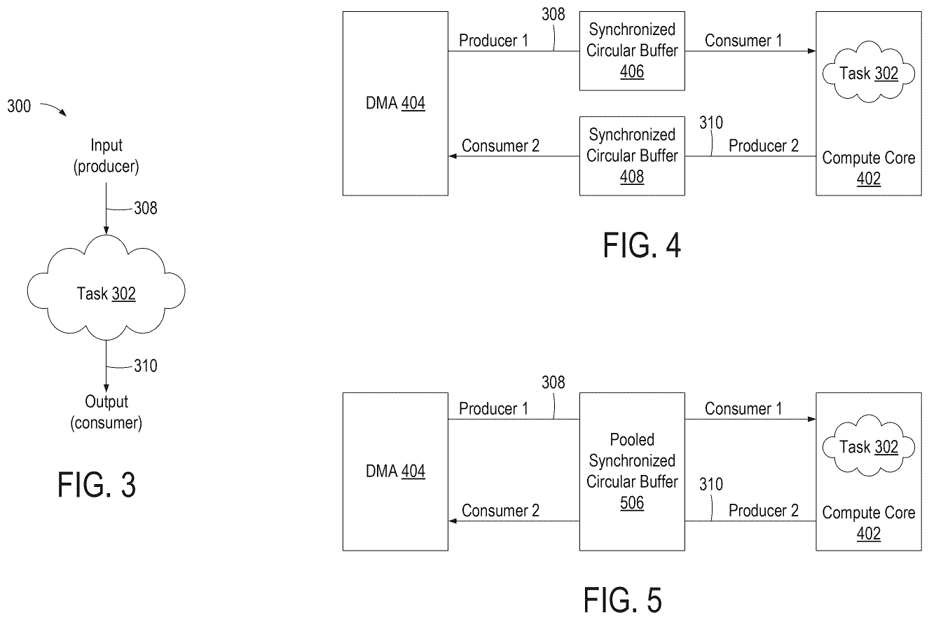

FIG. 3 depicts a logical graph 300 of a task 302 to be mapped to a computing platform, according to an embodiment. In FIG. 3, task 302 receives/consumes tokens 308 from a producer (e.g., another task/process), and outputs/produces tokens 310.

FIG. 4 depicts an example mapping of task 302, according to an embodiment. In the example of FIG. 4, compiler 200 maps task 302 to a compute core 402, a DMA 404 produces tokens 308 to compute core 402 via a first synchronized circular buffer 406, and compute core 402 produces tokens 310 to DMA 404 via a second synchronized circular buffer 408. Compute core 402 and DMA 404 may represent a core 106 and a DMA 108 of a same compute tile 102 in FIG. 1, and synchronized circular buffers 406 and 408 may reside within local data memory 110 of the same compute tile 102. Alternatively, compute core 302, DMA 304, synchronized circular buffer 402, and synchronized circular buffer 404 may be distributed amongst multiple compute tiles 102 (e.g., adjacent compute tiles). In the example of FIG. 4, DMA 404 serves as a producer of tokens 318 and a consumer of tokens 310. Compute core 402 serves as a consumer of tokens 318 and a producer of tokens 310.

FIG. 5 depicts an alternative mapping of task 302, according to an embodiment. In the example of FIG. 5, after analyzing access patterns of consumer and producer processes of task 302, compiler 200 maps task 302 to compute core 402, and DMA 404 and compute core 402 exchange tokens 308 and 310 via a pooled synchronized buffer 506. Compute core 402 and DMA 404 may represent a core 106 and a DMA 108 of the same compute tile 102 in FIG. 1, and pooled synchronized buffer 506 may reside within local data memory 110 of the same compute tile 102. Alternatively, compute core 402, DMA 404, and pooled synchronized buffer 506 may be distributed amongst multiple compute tiles 102. A memory footprint (e.g., depth) of pooled synchronized buffer 506 may be less than a sum of memory footprints (e.g., depths) of synchronized circular buffers 406 and 408, examples of which are provided further below. Buffer depth may be expressed in terms of numbers of tokens.

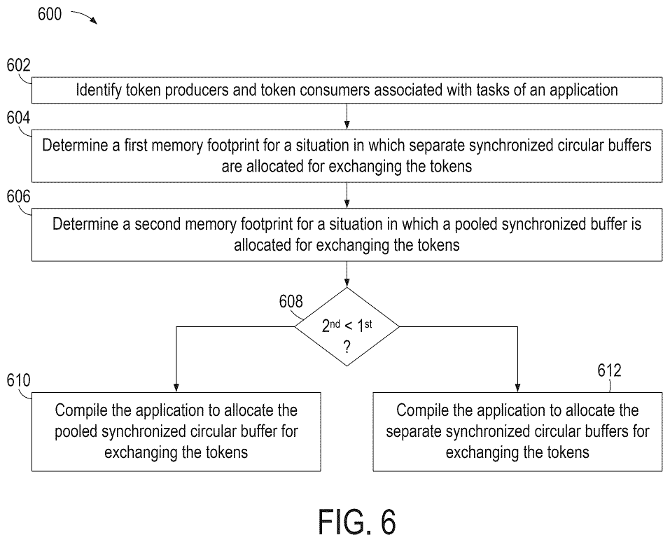

FIG. 6 depicts a method 600 of allocating memory pools on spatial compute architectures, according to an embodiment. Method 600 is described below with reference to FIGS. 1-5. Method 600 is not, however, limited to the examples of FIGS. 1-5.

At 602, compiler 200 identifies producer and consumer processes of application 202 that are suitable for spatial memory pools. Compiler 200 may focus on producer and consumer processes that are mapped to co-located compute tiles 102 (i.e., compute tiles 102 that have direct access to the local data memory 110 of one another).

At 604, compiler 200 determines a first memory footprint for a situation in which separate synchronized circular buffers are allocated for synchronized producer/consumer pairs. A producer/consumer pair may rely on resources of a synchronized circular buffer to achieve a synchronized exchange where data is consumed only after the producer has finished producing, and new data is produced only after the consumer has finished consuming the previous data.

In FIG. 4, process mapper/router 206 may determine the first memory footprint based on a sum of depths (i.e., memory sizes) of synchronized circular buffers 406 and 408. Compiler 200 may evaluate access/fire patterns (i.e., execution order and/or data access pattern order) of core 402 and DMA 404 under a preferred/pre-selected (collectively, specified) execution order (e.g., all processes execute concurrently to enable their mapping to different cores), and may determine the total memory footprint by accumulating the depths of the synchronized circular buffers.

At 606, compiler 200 determines a second memory footprint for a situation in which a pooled synchronized circular buffer is allocated for the synchronized producer/consumer pairs. In FIG. 5, compiler 200 may determine the second memory footprint as a depth of pooled synchronized circular buffer 506. Compiler 200 may determine the depth based on access/fire patterns of the producer and consumer processes associated with task 302, under the specified execution order.

At 608, if the second footprint is less than the first footprint, processing proceeds to 610, where compiler 200 compiles application 202 to allocate pooled synchronized circular buffer 506 for the producer/consumer processes of task 302. In addition, scheduler 212 may generate schedules 214 to configure spatial synchronization constraints to enforce the specified execution order.

If the second footprint is not less than the first footprint, compiler 200 may to compile application 202 to allocate pooled synchronized circular buffer 506 for the producer/consumer processes of task 302 at 608, or may compile application 202 to allocate separate synchronized circular buffers 406 and 408 for the producer/consumer processes of task 302 at 612.

Additional examples are provided below.

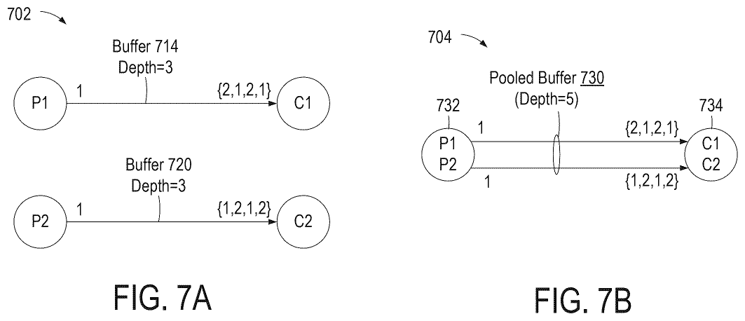

FIG. 7A depicts a graph 702 of producer/consumer processes, according to an embodiment. In FIG. 7A, a producer node P1 provides tokens to a consumer node C1 via a synchronized circular buffer 714. Another producer node P2 provides tokens to another consumer node C2 via a synchronized circular buffer 720. A preferred execution order is such that all of nodes P1, C1, P2, and C2 execute concurrently once they reach stable states.

In the example of FIG. 7A, node P1 produces 1 token per execution/firing, which, and node C1 consumes tokens in a pattern of {2, 1, 2, 1}. In this example, buffer 714 may have a minimum depth of 3 tokens to accommodate token exchanges between nodes P1 and C1 when node C1 consumes 2 tokens per execution/firing (i.e., to ensure concurrent execution/firing). Further in the example of FIG. 7A, node P2 produces 1 token per execution/firing, and node C2 consumes tokens in a pattern of {1, 2, 1, 2}. In this example, buffer 720 may have a minimum depth of 3 tokens to accommodate token exchanges between nodes P2 and C2 when node C2 consumes 2 tokens per execution/firing. The total memory footprint for graph 702 is thus 6 tokens.

In FIG. 7A, nodes C1 and C2 exhibit mutually exclusive (e.g., differing or non-overlapping) token consumption patterns. Compiler 200 may exploit the mutually exclusive token consumption patterns to reduce the memory footprint, such as described below with reference to FIG. 7B.

FIG. 7B depicts a graph 704 of the producer/consumer processes of FIG. 7A, conducted via a pooled synchronized circular buffer 730, according to an embodiment. In FIG. 7B, producer nodes P1 and P2 are depicted as a node 732, and consumer nodes C1 and C2 are depicted as a node 734, for illustrative purposes. In this example, node 732 produces 2 tokens per execution/firing, and node 734 consumes 3 tokens per execution execution/firing. Compiler 200 may provide pooled buffer 730 with a minimum depth of 5 tokens because, at a maximum, for concurrent execution, consumers nodes C1 and C2 require 3 objects to fire, and producer nodes P1 and P2 use 2 additional tokens. Since the memory footprint of graph 704 is less than the memory footprint of graph 702, compiler 200 may compile application 202 as depicted in graph 704 rather than graph 702.

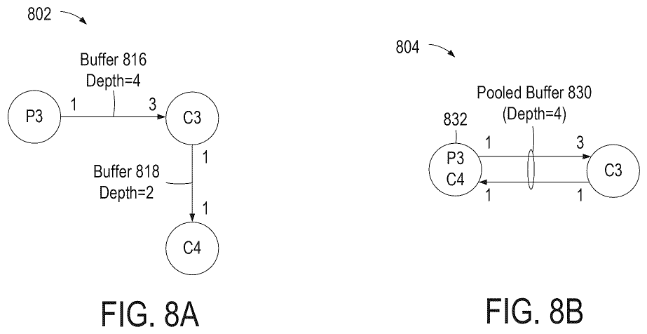

FIG. 7B represents an example of method 600, performed based on numbers of tokens exchanges and cyclo-static patterns. This may be referred to as a token-level granularity. Method 600 may be performed within token granularity, based on knowledge of access patterns within tokens and enforceable constraints, such as described below with reference to FIGS. 8A and 8B.

FIG. 8A depicts a graph 802 of producer/consumer processes, according to an embodiment. In FIG. 8A, a producer node P3 produces provides tokens to a consumer node C3 via a synchronized circular buffer 816. Consumer node C3, also serves as a producer node that produces tokens to a consumer node C4 via a synchronized circular buffer 818. A preferred execution order is such that all of nodes P3, C3, and C4 execute concurrently once they reach stable states.

In the example of FIG. 8A, producer node P3 produces 1 token per execution/firing, consumer node C3 consumes 3 tokens per execution/firing, and produces 1 token per execution/firing, and consumer node C4 consumes 1 token per execution/firing. Compiler 200 may provide buffer 816 with a minimum depth of 4 tokens, and may provide buffer 818 with a minimum depth of 2 tokens, for a total memory footprint of 6 tokens, to ensure concurrent execution. Alternatively, compiler 200 may exploit differences in the token production/consumption patterns (e.g., based on a preferred/specified execution/firing order), such as described below with respect to FIG. 8B.

FIG. 8B depicts a graph 804 of the producer/consumer processes of FIG. 8A, conducted via a pooled synchronized circular buffer 830, according to an embodiment. In FIG. 8B, compiler 200 fuses producer node P3 and consumer node C4 into a single node 832, and further fuses the tokens produced by node P3 and the tokens consumed by node C4 by enforcing a specified firing order in which node C4 reads (i.e., consumes) tokens prior to node P1 writing (i.e., producing) tokens. In other words, producer node P3 and consumer node C4 will be assigned to the same core 106 and scheduling constraints will be applied such that they execute sequentially (i.e., producer node P3 and consumer node C4 will not execute simultaneously). In this example, when P3 produces 1 token and C3 consumes 3 tokens, a depth of 4 tokens is needed. After P3 produces the 1 token and C3 consumes the 3 tokens, node C3 produces 1 token and node C4 consumes 1 token, in which case a depth of 2 tokens is needed. In this situation, compiler 200 may provide pooled synchronized circular buffer with a depth of 4 tokens, and may generate schedules 214 to enforce the specified execution order in which nodes P3 and C3, and nodes C3 and C4 execute concurrently while node C2 fires/executes before node P1.

Since the memory footprint of graph 804 is less than the memory footprint of graph 802, compiler 200 may compile application 202 as depicted in graph 804 rather than graph 802.

In addition to considering cyclo-static firing/access patterns, compiler 200 may exploit run-time temporal scheduling of processes of application 200 (e.g., disparate execution times) to reduce a memory footprint.

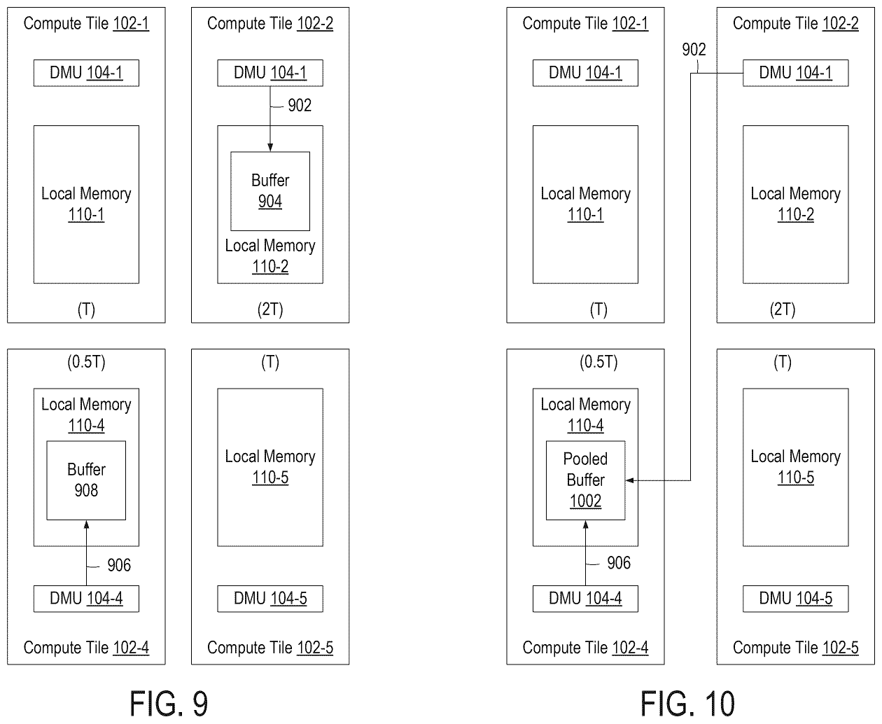

FIG. 9 depicts a subset of compute tiles of system 100, according to an embodiment. In FIG. 9, compute tiles 102-1, 102-2, 102-4, and 102-5 are depicted with relative times for executing respective processes and producing respective tokens. In this example, compute tile 102-2 executes a producer process that provides tokens 902 to a synchronized circular buffer 904 in local data memory 110-2 in intervals of 2 T, and compute tile 102-4 executes a producer process that provides tokens 906 to a synchronized circular buffer 908 in local data memory 110-4 in intervals of 0.5 T. In other words, DMU 104-4 writes tokens 906 to buffer 908 four times the frequency that DMU 104-2 writes tokens 902 to buffer 904. Compiler 200 may exploit the disparate execution times of the processes executing on compute tiles 110-2 and 110-4, using synchronization resources of system 100, to reduce a memory footprint of the processes, such as described below with reference to FIG. 10.

FIG. 10 depicts the subset of compute tiles of system 100 of FIG. 9, according to an embodiment. In the example of FIG. 10, compiler 200 allocates a pooled synchronized circular buffer (buffer) 1002 in local data memory 110-4 for tokens 902 and 906. Compiler 200 may further generate compiled application 216 such that DMUs 104-1 and 104-4 write tokens 902 and 906 to the same space or memory address/addresses of buffer 1002, with synchronization protections to preclude collisions (i.e., simultaneous accesses) in the event that DMUs 104-1 and 104-4 attempt to write tokens 902 and 906 to buffer 1002 at the same time. Since the execution times of compute tiles 102-2 and 102-4 are disparate, DMUs 104-1 and 104-4 may rarely or may never attempt to write tokens 902 and 906 to buffer 1002 at the same time. If DMUs 104-1 and 104-4 attempt to write tokens 902 and 906 to buffer 1002 at the same time, the synchronization protections may briefly delay one of DMUs 104-1 and 104-4 from writing to buffer 1002, but the impact may be minimal and may be considered a fair tradeoff for a reduced memory footprint. Compiler 200 may thus utilize synchronization resources of system 100 to ensure that the slower process of compute tile 102-4 are not blocked from accessing buffer 1002 when compute tile 102-4 finishes executing the slower process, and that the faster process of compute tile 102-4 can continuously make forward progress. More generally, compiler 200 may utilize synchronization resources of system 100 and allocate pools with memory resources sufficient to ensure execution under expected execution circumstances, but less than the maximum possible amount of resources that could be used by processes sharing the pool (e.g., without synchronization constraints).

The foregoing methods leverage synchronization capabilities of a spatial architecture to ensure that it is safe to exploit the access patterns to combine data of multiple processes in a shared memory pool.

The foregoing methods may be useful to provide memory management in real-time systems where several same-sized memory locations are pre-allocated at compile time and accessed in constant time at runtime.

The foregoing methods may be useful for spatial data flow/compute architectures having limited memory and hardware synchronization resources. Methods disclosed herein are not, however, limited to spatial compute architectures having limited memory and hardware synchronization resources.

The foregoing methods may be useful to reduce a memory footprint of an application executing on a spatial compute architecture.

The foregoing methods may be useful to optimize a memory footprint of an application with respect to a hierarchical memory structure of a spatially distributed architecture.

Dynamic allocation of work and data on spatial compute architectures is described below with reference to FIGS. 1A, 1B, 1C, and 11 through 13.

In a spatial compute architecture, decisions such as mapping workloads to compute units, configuring the routing resources and allocating memory space at different levels of the hierarchy can be taken statically at compile-time, such as described further above. As described below, at least some of these decisions may be deferred to application runtime.

As described below, a compiler compiles an application to execute on a spatially distributed architecture, without mapping or assigning all tasks/processes of the application to specific compute tiles. Instead, the compiler generates task code and corresponding task data for one or more tasks/processes of the application, and generates code for one or more lead dispatch nodes to dynamically assign the tasks to compute tiles at runtime. In an example, local data memories of neighboring compute tiles are pooled to provide each compute tile with a respective local data memory pool, and the lead dispatch node(s) dynamically assign task code and task data to the compute tiles based on availability of memory within the respective local data memory pools.

A compute tile or other or dedicated dispatch hardware may designated as a lead dispatch node, and other compute tiles may be designated as task nodes. Mailboxes of the lead dispatch node(s) and task nodes may be used to direct allocation requests and work to available spatial resources. Data storage, compute cores, and routing resources may be treated as pooled resources that can be allocated and deallocated within the spatial compute fabric at runtime. A packet-switched network-on-chip (NoC) may be used to route data and requests to destination resources based on headers attached to payloads.

In an example, multiple lead dispatch nodes may dynamically assign tasks to respective subsets of compute tiles. Multiple lead nodes may also synchronize and communicate with one another. As an example, and without limitation, a first lead dispatch node may send a message to a second lead dispatch node to transfer a task in the event that compute tiles associated with the first lead dispatch node decline to accept the task. Multiple lead nodes may share a pooled synchronized circular buffer (e.g., to exchange tasks).

Techniques disclosed herein enable dynamic resource aware routing within spatial architectures for both work and data. The work may include configuration data for a tile or set of tiles in a spatial architecture, along with code or bytecode directing computations executed using application data. In an example, code and data for compute kernels and associated DMA configuration parameters are encapsulated in “active” messages (i.e., “fat” or “thick” messages), that are dynamically routed by the lead dispatch node or dedicated dispatch hardware to available regions of compute resources. An active message is a message that contains all or substantially of the code, data, and configuration data/parameters (or a pointer thereto), that a task node needs to execute a task. The configuration data/parameters may include, without limitation, code (e.g., DMA programs and/or core programs) and/or register/parameter writes.

Active messages enable dynamic assignment of tasks amongst task nodes (i.e., disaggregation of work/data across a spatial compute architecture). A task node may accept or reject a dispatched messages based on pooled resource availability.

A lead dispatch node may route, evict, and relocate code, data, and configuration parameters amongst memory scratchpads in a multi-level hierarchy. In an example, a lead dispatch node routes code, data, and configuration parameters for a task, from external memory to a local data memory pool accessible to a selected task node. In some situations (e.g., upon rejection by a selected task node), a lead dispatch node may route the data, code, and configuration data to a temporary memory location (i.e., a scratchpad), before routing the data, code, and configuration data to the local data memory pool of the selected task node. The temporary memory location may be another local data memory pool or a shared memory tile 114. Temporary storage may be useful when there is insufficient available space in the memory pool of the selected task node and/or when the selected task node is unavailable/busy. Temporary storage may be useful to extend a lifetime of the data.

Dynamic (i.e., runtime) allocation of work and data differs from static compiling in several respects. With static compiling, compute resources are assigned at compile-time and remain fixed during runtime. In such a situation, tasks that are only executed once may leave a resource unusable for other work, effectively reducing the amount of resources available for a full task queue. Whereas dynamic allocation of work and data, resources are allocated dynamically at runtime and can be reconfigured for new tasks, thus increasing the pool of available resources in the spatial compute fabric.

Methods for memory, communication, and compute pooling over a spatially distributed compute architecture, described below, may be useful in situations where there are memory constraints, routing constraints, compute constraints, and/or hardware synchronization resource constraints.

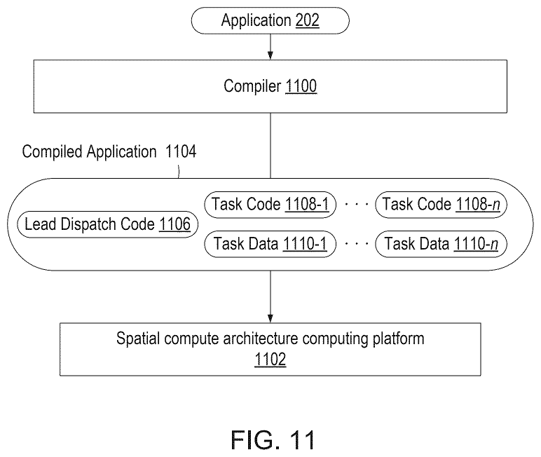

FIG. 11 depicts a compiler 1100 that compiles application 202 to execute on a spatial compute architecture computing platform (computing platform) 1102 as a compiled application 1104 (i.e., machine-readable code), according to an embodiment. In examples below, computing platform 1102 represents system 100. Computing platform 1102 is not, however, limited to the example of system 100. Compiler 1100 may include one or more features described above with respect to compiler 200 in FIG. 2.

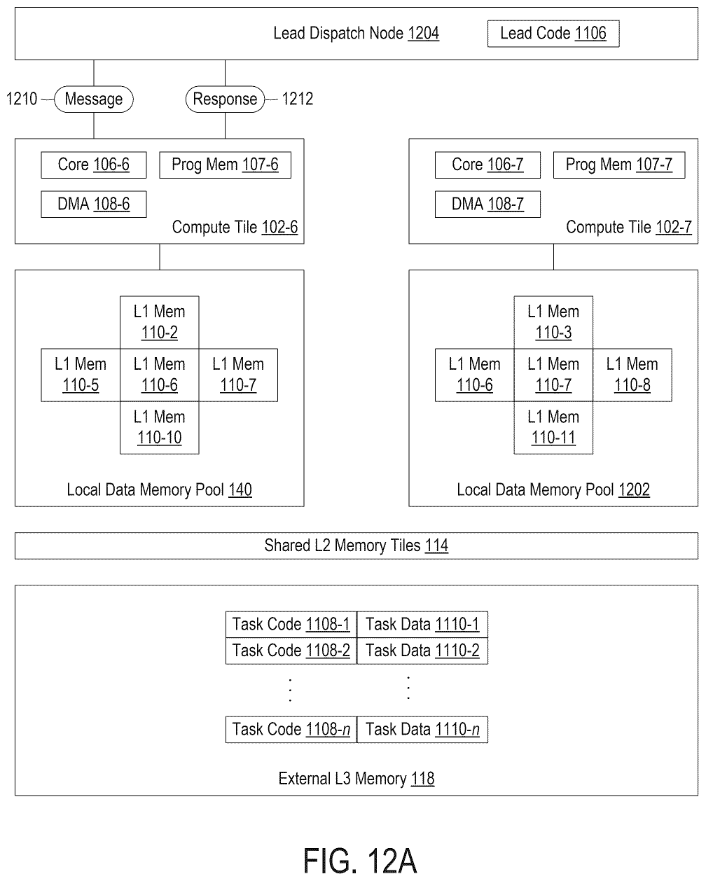

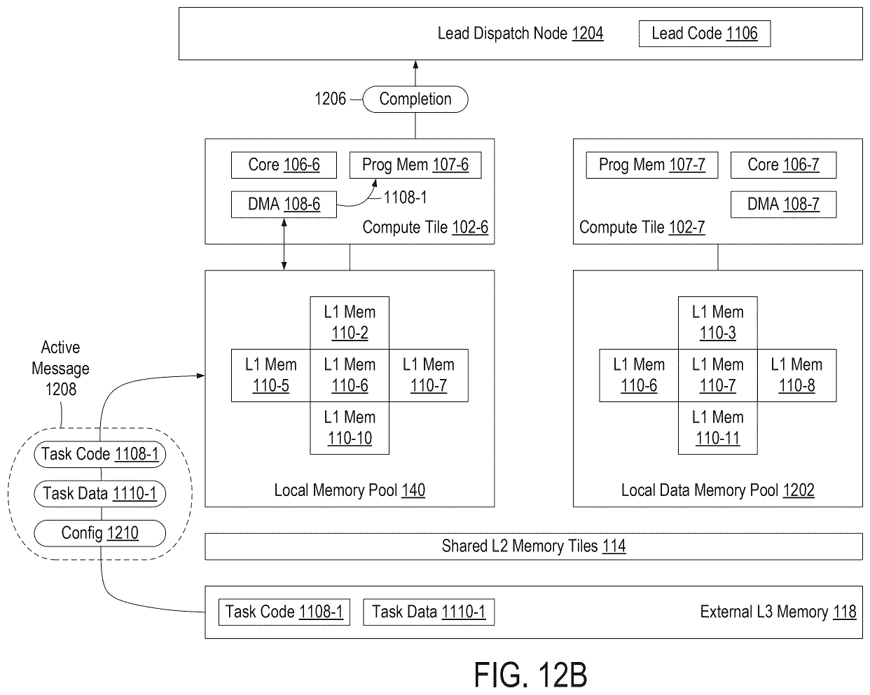

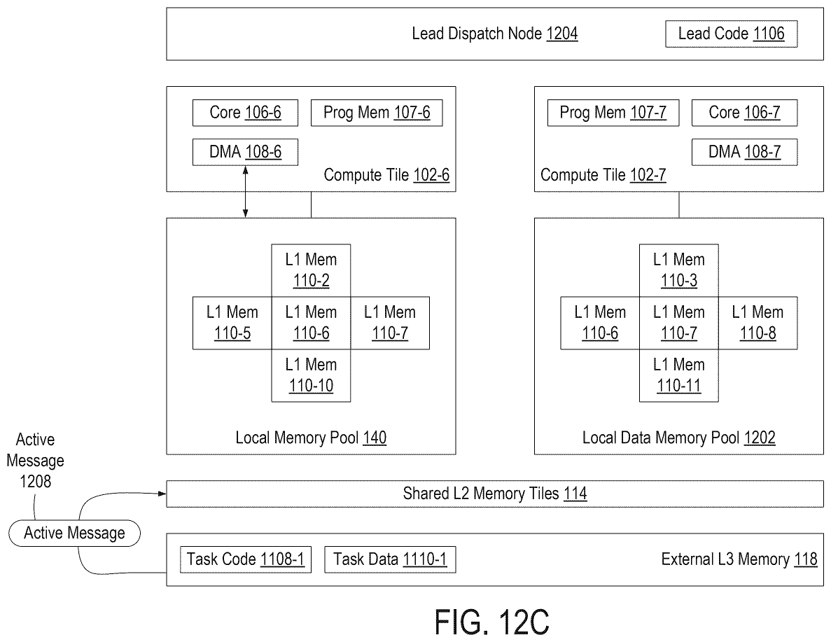

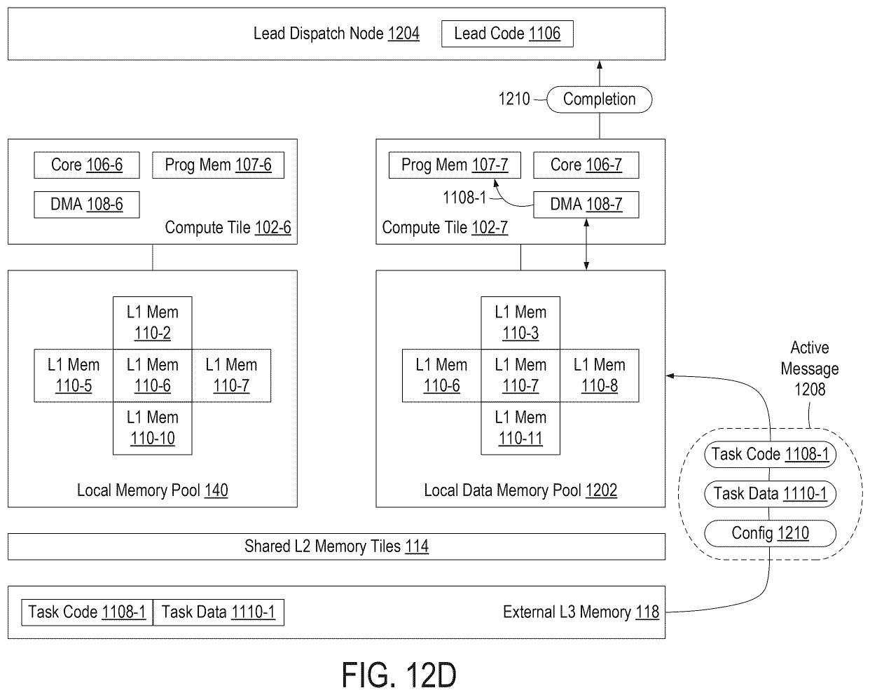

FIGS. 12A through 12D depict local data memory pool (memory pool) 140 of compute tile 102-6, and a local data memory pool (memory pool) 1202 of compute tile 102-7, according to an embodiment. In the examples of FIGS. 12A through 12D, memory pool 1202 includes local data memory 120-7 of compute tile 102-7 and local data memories 120-3, 120-6, 120-8, and 120-11 of respective compute tiles 102-3, 102-6, 102-8, and 102-11. A core 106-7 of compute tile 102-7 may directly access all of the local memories of memory pool 1240. The local memories included in memory pool 1202 may be configurable via configurable interconnect structures.

FIGS. 12A through 12D further depict a lead dispatch node 1204. Lead dispatch node 1204 may represent one or more other compute nodes 102 and/or dedicated hardware. Other compute nodes 102 may be designated as task nodes.

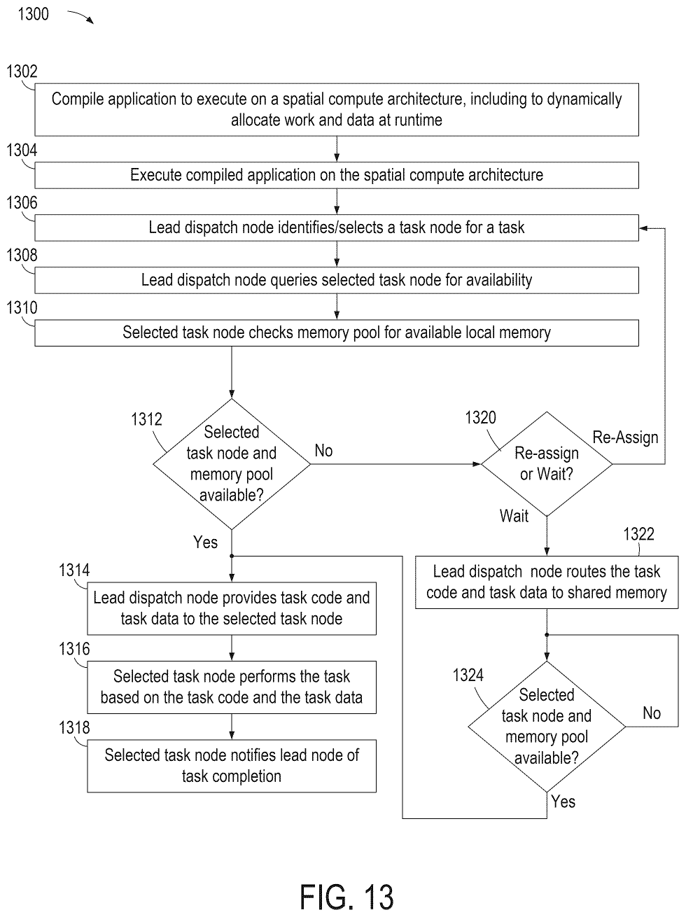

FIGS. 11 and 12A through 12D are described below with reference to FIG. 13. FIG. 13 depicts a method 1300 of dynamically allocating work and data on a spatial compute architecture, according to an embodiment. Method 1300 is described below with reference to FIGS. 11 and 12A through 12D. Method 1300 is not, however, limited to the examples of FIGS. 11 and 12A through 12D.

At 1302, compiler 1100 compiles application 202 to execute on system 100, without mapping or assigning all tasks/processes of application 202 to specific compute tiles 102. Instead, compiler 1100 compiles application 202 to generate lead dispatch code 1106 for lead dispatch node 1204, and to generate task code 1108-1 through 1108-n, and corresponding task data 1110-1 through 1118-n, for the one or more tasks or processes. Lead dispatch code 1106 may include information regarding tasks of application 202 that are to be assigned to task nodes of system 100. Compiler 200 may also generate core code 218 and controller code 220 for one or more one more compute tiles 102 (e.g., for other tasks/processes of application 202).

At 1304, system 100 executes compiled application 1104. In an example, compiled application 1104 is initially stored in external L3 memory 118, and program memory of lead dispatch node 1204 includes a pointer to lead dispatch code 1106. Following a boot-phase of system 100, lead dispatch node 1204 may move lead dispatch code 1106 to program memory of lead dispatch node 1108, and may execute lead dispatch code 1106 from the program memory.

At 1306, while executing lead dispatch code 1106, lead dispatch node 1204 selects compute tile 102-6 to perform a task of application 202. In an example, the task relates to task code 1108-1 and task data 1110-1.

At 1308, lead dispatch node 1204 queries core 106-6 of compute tile 102-6. In FIG. 11A, lead dispatch node 1204 sends a query message 1110 to compute tile 102-6. Query message 1110 may include, without limitation, information about the task and an indication of how much local data memory is needed for the task.

At 1310, core 102-6 determines whether local data memory pool 140 has sufficient free/available space for the task, and provides a response 1112. Response may include a positive response that indicates that there is sufficient free space in local data memory pool 140, and that core 102-6 is available to execute the task. A positive response may further include information about the available memory space within local data memory pool 140. The information may specify the available memory space (e.g., an address/address range). Alternatively, response 1112 may include a negative response that indicates that there is insufficient free space in local data memory pool 140, and/or that core 102-6 is unavailable to execute the task.

As described above with reference to 1306, lead dispatch node 1204 selects compute tile 102-6 to perform a task of application 202. Alternatively, lead dispatch node 1204 may broadcast query message 1110 to multiple compute tiles 102, and may select a compute tile 102 as the task node based on responses from the compute tiles.

At 1312, if response 1112 is positive, processing proceeds to 1314, where lead dispatch node 1204 routes task code 1108-1 and task data 1110-1 to compute tile 102-6. In FIG. 12B, lead dispatch node 1204 routes task code 1108-1 and task data 1110-1 to the specified available space of local data memory pool 140, based on the information provided in response 1212.

Lead dispatch node 1204 may further provide configuration information. The configuration information may include information to permit core 106-6 and/or DMA 108-6 to retrieve task code 1108-1 from local data memory pool 140 and store task code 1108-1 in program memory 107-6 of compute tile 102-6. The configuration information may include information to permit core 106-6 to access task data 1110-6 within local data memory pool 140.

Lead dispatch node 1204 may route task code 1108-1, task data 1110-1, and associated configuration parameters 1210 (or a pointer thereto) as an active message 1208.

At 1316, core 102-6 executes task code 1108-1 based on task data 1110-1, to perform the task. Core 102-6 may perform the task based further on other/additional data. In an example, task code 1108-1 includes task code to cause core 102-6 to allocate a pooled synchronized circular buffer, such as described further above with reference to FIGS. 2 through 10, dynamically at application runtime.

At 1318, core 102-6 may notify lead dispatch node 1204 upon completion of the task. In FIG. 12B, core 102-6 sends a completion message 1206 to lead dispatch node 1204.

Returning to 1312, if response 1112 is negative, processing proceeds to 1320, where lead dispatch node 1204 may wait for space to become available within local data memory pool 140, or may seek available space in the local data memory pool of another compute tile 102. If lead dispatch node 1204 waits for space to become available within local data memory pool 140, processing may proceed to 1322, where lead dispatch node 1204 stores (e.g., moves or routes) task code 1108-1 and task data 1110-1 to a shared L2 memory tile 114, such as illustrated in FIG. 12C. At 1324, when core 102-6 and space within local data memory pool 140 become available, processing proceeds to 1314, where lead dispatch node 1204 provides task code 1108-1 and task data 1110-1 from the shared L2 memory tile 114 to compute tile 102-6, such as described further above with reference to FIG. 12B.

Returning to 1320, if lead dispatch node 1204 is to seek available space in the local data memory pool of another compute tile 102, processing may return to 1306, where lead dispatch node 1204 may select compute tile 102-7, and may query compute tile 102-7 at 1308, such as described above with reference to FIG. 12A. If compute tile 102-7 provides a positive response, lead dispatch node 1204 may provide task code 1108-1 and task data 1110-1 to local data memory pool 1102, such as illustrated in FIG. 12D. Upon completion of the task, core 106-7 may provide a completion message 1210 to lead dispatch node 1204.

Alternatively, at 1320, lead dispatch node 1204 may forward task code 1108-1 and task data 1110-1 to another lead dispatch node of system 100.

In the preceding, reference is made to embodiments presented in this disclosure. However, the scope of the present disclosure is not limited to specific described embodiments. Instead, any combination of the described features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the preceding aspects, features, embodiments and advantages are merely illustrative and are not considered elements or limitations of the appended claims except where explicitly recited in a claim(s).

As will be appreciated by one skilled in the art, the embodiments disclosed herein may be embodied as a system, method or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium is any tangible medium that can contain, or store a program for use by or in connection with an instruction execution system, apparatus or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object-oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods, and computer program products according to various examples of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing is directed to specific examples, other and further examples may be devised without departing from the basic scope thereof, and the scope thereof is determined by the claims that follow.

What is claimed is:

1. An integrated circuit, comprising:
multiple compute tiles that comprise respective compute cores, program memory, and local data memory; and
a first lead dispatch node comprising one or more of dedicated hardware and one of the compute tiles;
wherein,
the compute cores are configured to access the program memories, the local data memories, and local data memory pools of the respective compute tiles,
the local data memory pools each comprise the local data memory of the respective compute tile and the local data memory of one or more other ones of the compute tiles, and
the first lead dispatch node is configured to dynamically assign a first task of an application to a selected one of the compute tiles, and to route a corresponding first active message to the local data memory pool of the selected compute tile, wherein the first active message comprises instructions and data to enable the selected compute tile to execute the first task.

2. The integrated circuit of claim 1, wherein:
the integrated circuit further comprises a shared memory tile that is accessible to the compute tiles, and configurable interconnect structures; and
the first lead dispatch node is further configured to route the first active message to the local data memory pool of the selected compute tile from one of the shared memory tile and an external memory.

3. The integrated circuit of claim 2, wherein:
the first active message further comprises configuration data to enable the selected compute tile to execute the first task.

4. The integrated circuit of claim 1, wherein:
the first lead dispatch node is further configured to query the compute core of the selected compute tile to determine if the local data memory pool of the selected compute tile has available space for the first active message;
the compute core of the selected compute tile is further configured to accept the first task and provide an identifier of the available space to the first lead dispatch node if the local data memory pool of the selected compute tile has the available space for the first active message; and
the first lead dispatch node is further configured to route the first active message to the available space of the local data memory pool of the selected compute tile based on the identifier.

5. The integrated circuit of claim 4, wherein:
the compute core of the selected compute tile is further configured to decline the first task if the local data memory pool of the selected compute tile lacks the available space for the first active message;
the first lead dispatch node is further configured to route the first active message to one of a shared memory tile and the local data memory pool of another one of the compute tiles if the compute core of the selected compute tile declines the first task; and
the first lead dispatch node is further configured to route the first active message to the local data memory pool of the selected compute tile when the local data memory pool of the selected compute tile has the available space for the first active message.

6. The integrated circuit of claim 1, wherein the first lead dispatch node is further configured to:
dynamically select one of the compute tiles as the selected compute tile based on pending tasks of the compute tiles.

7. The integrated circuit of claim 1, further comprising a second lead dispatch node, wherein:
the first lead dispatch node is configured to dynamically assign the first task to a selected compute tile of a first set of the compute tiles;
the second lead dispatch node is configured to dynamically assign a second task of the application to a selected compute tile of a second set of the compute tiles, and to route a corresponding second active message to the local data memory pool of the selected compute tile of the second set of compute tiles; and
the first lead dispatch node is further configured to dynamically assign the first task to the second lead dispatch node if the first task is declined by one or more of the compute tiles of the first set of compute tiles.

8. The integrated circuit of claim 7, wherein:
the first lead dispatch node is further configured to route the first active message to the second lead dispatch node via a pooled synchronized circular buffer that is accessible to the first and second lead dispatch nodes.

9. The integrated circuit of claim 1, wherein the first task comprises consuming tokens from a first token producer, as a first token consumer, and producing tokens to a second token consumer, as second token producer, and wherein the first lead dispatch node is further configured to:
determine a first minimum buffer depth based on a first synchronous token exchange pattern of the first token producer and the first token consumer;
determine a second minimum buffer depth based on a second synchronous token exchange pattern of the second token producer and the second token consumer;
determine a pooled buffer depth based on the first and second synchronous token exchange patterns and instances of mutual exclusiveness between the first and second synchronous token exchange patterns; and
allocate a pooled synchronized circular buffer, having the pooled buffer depth, in the local data memory pool of the selected compute tile if the pooled buffer depth is less that a sum of the first and second buffer minimum depths, such that the first and second token producers provide tokens to the first and second token consumers, respectively, via the pooled synchronized circular buffer.

10. A non-transitory computer readable medium encoded with a computer program that comprises instructions to cause a processor to:
compile an application to execute on a spatial compute architecture that comprises multiple compute tiles that comprise respective compute cores, program memory, and local data memory, and that further comprises a first lead dispatch node that comprises one or more of dedicated hardware and one of the compute tiles, wherein the compute cores are configured to access the program memories, the local data memories, and local data memory pools of the respective compute tiles, and wherein the local data memory pools each comprise the local data memory of the respective compute tile and the local data memory of one or more other ones of the compute tiles, including to compile the application such that,
the first lead dispatch node dynamically assigns a first task of the application to a selected one of the compute tiles, and routes a corresponding first active message to the local data memory pool of the selected compute tile, wherein the first active message comprises instructions and data to enable the selected compute tile to execute the first task.

11. The non-transitory computer readable medium of claim 10, wherein:
the integrated circuit further comprises a shared memory tile that is accessible to the compute tiles, and configurable interconnect structures; and
the first lead dispatch node is further configured to route the first active message to the local data memory pool of the selected compute tile from one of the shared memory tile and an external memory.

12. The non-transitory computer readable medium of claim 10, wherein the computer program further comprises instructions to cause the processor to compile the application such that:
the first lead dispatch node is further configured to query the compute core of the selected compute tile to determine if the local data memory pool of the selected compute tile has available space for the first active message;
the compute core of the selected compute tile is further configured to accept the first task and provide an identifier of the available space to the first lead dispatch node, if the local data memory pool of the selected compute tile has the available space for the first active message; and
the first lead dispatch node is further configured to route the first active message to the available space of the local data memory pool of the selected compute tile based on the identifier.

13. The non-transitory computer readable medium of claim 12, wherein the computer program further comprises instructions to cause the processor to compile the application such that:
the compute core of the selected compute tile is further configured to decline the first task if the local data memory pool of the selected compute tile lacks the available space for the first active message;
the first lead dispatch node is further configured to route the first active message to one of a shared memory tile and the local data memory pool of another one of the compute tiles, if the compute core of the selected compute tile declines the first task; and
the first lead dispatch node is further configured to re-route the first active message to the local data memory pool of the selected compute tile when the local data memory pool of the selected compute tile has the available space for the first active message.

14. The non-transitory computer readable medium of claim 10, wherein the a spatial compute architecture further comprises a second lead dispatch node, and wherein the computer program further comprises instructions to cause the processor to compile the application such that:
the first lead dispatch node is configured to dynamically assign the first task to a selected compute tile of a first set of the compute tiles;
the second lead dispatch node is configured to dynamically assign a second task of the application to a selected compute tile of a second set of the compute tiles, and to route a corresponding second active message to the local data memory pool of the selected compute tile of the second set of compute tiles; and
the first lead dispatch node is further configured to dynamically assign the first task to the second lead dispatch node if the first task is declined by one or more of the compute tiles of the first set of compute tiles.

15. The non-transitory computer readable medium of claim 14, wherein the computer program further comprises instructions to cause the processor to compile the application such that:
the first lead dispatch node is further configured to route the first active message to the second lead dispatch node via a pooled synchronized circular buffer that is accessible to the first and second lead dispatch nodes.

16. A method, comprising:
executing an application on a computing platform that comprises multiple compute tiles that comprise respective compute cores, program memory, and local data memory, and that further comprises a lead dispatch node that comprises one or more of dedicated hardware and one of the compute tiles, wherein the compute cores are configured to access the program memories, the local data memories, and local data memory pools of the respective compute tiles, and wherein the local data memory pools each comprise the local data memory of the respective compute tile and the local data memory of one or more other ones of the compute tiles, and wherein the executing comprises,
assigning a task of the application to a selected one of the compute tiles, by the lead dispatch node, and
routing a corresponding active message to the local data memory pool of the selected compute tile, by the lead dispatch node;
wherein the first active message comprises instructions and data to enable the selected compute tile to execute the task.

17. The method of claim 16, wherein the integrated circuit further comprises a shared memory tile that is accessible to the compute tiles, and configurable interconnect structures, and wherein and the routing comprises:
routing the active message to the local data memory pool of the selected compute tile from one of the shared memory tile and an external memory.

18. The method of claim 16, further comprising:
querying the compute core of the selected compute tile to determine if the local data memory pool of the selected compute tile has available space for the active message;
accepting the task and providing an identifier of the available space to the lead dispatch node, by the compute core of the selected compute tile, if the local data memory pool of the selected compute tile has the available space for the active message; and
routing the active message to the available space of the local data memory pool of the selected compute tile based on the identifier, if the compute core of the selected compute tile accepts the task.

19. The method of claim 18, wherein the routing further comprises:
routing the active message to one of a shared memory tile and a local data memory pool of another one of the compute tiles, if the compute core of the selected compute tile declines the task; and
routing the active message to the local data memory pool of the selected compute tile when the local data memory pool of the selected compute tile has available space for the active message.

20. The method of claim 16, wherein the assigning comprises:
dynamically selecting one of the compute tiles as the selected compute tile based on pending tasks of the compute tiles.
